(19) United States
(12) Patent Application Publication
(10) Pub. No.: US 2016/0110097 A1
(43) Pub. Date: Apr. 21, 2016

(54) DISPLAY DEVICE AND METHOD OF CONTROLLING THEREFOR

(71) Applicant: LG ELECTRONICS INC., Seoul (KR)

(72) Inventor: Eunhyung CHO, Seoul (KR)

(73) Assignee: LG ELECTRONICS INC., Seoul (KR)

(21) Appl. No.: 14/516,272

(22) Filed: Oct. 16, 2014

(51) Int. Cl. G06F 3/0488; G09G 5/373; G09G 5/37; G06F 1/16; G06F 3/041

(52) U.S. Cl. CPC G06F 3/04886; G06F 1/1652; G06F 3/0418; G09G 5/37; G09G 5/373; G09G 2380/02; G09G 2340/14; G09G 2320/08

(57) ABSTRACT

A display device according to one embodiment of the present specification can include a flexible display unit. And, the display device can modify a virtual keyboard on the flexible display unit based on a bending state of the flexible display unit.

### BACKGROUND OF THE INVENTION

1. Field of the Invention

The present specification relates to a display device and an apparatus therefor.

2. Discussion of the Related Art

Such a portable display device as a smartphone and a tablet PC has been widely disseminated. As a function of the portable display device is diversified, a demand for a portable display device equipped with a wider display is increasing. And, in order to provide the wider display, various extendible display devices are studying. Moreover, a study on a flexible display device is performed to extend a display and increase portability at the same time.

FIG. 1 is a diagram for an example of a display device according to one embodiment.

The display device 100 shown in FIG. 1 includes a flexible display unit 120. In FIG. 1, a schematic form of the display device 100 is depicted only. As shown in FIG. 1, the flexible display unit 120 can be easily bent. As the flexible display unit 120 is bending, an image displayed on the flexible display unit 120 may be distorted.

And, although it is not depicted in FIG. 1, the display device 100 can provide an interface used for receiving an input. For instance, the display device 100 may provide a virtual keyboard. Yet, as mentioned in the foregoing description, as the flexible display unit 120 is bending, the virtual keyboard may be distorted. The distortion of the virtual keyboard may disturb an input of a user. Hence, it is necessary to have a method of preventing an input error due to distortion of an image displayed on the flexible display unit 120 and an apparatus therefor.

### SUMMARY OF THE INVENTION

Accordingly, the present specification is directed to an apparatus and method thereof that substantially obviate one or more problems due to limitations and disadvantages of the related art. An object of the present specification is to provide a method of providing a modified input means and an apparatus therefor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a display device includes a flexible display unit configured to display one or more contents, a bending sensing unit configured to detect a bending state of the flexible display unit and a processor configured to control the flexible display unit and the bending sensing unit, the processor further configured to display a virtual keyboard on the flexible display unit, the processor further configured to perform a modification of the virtual keyboard based on the detected bending state of the flexible display unit. The modification of the virtual keyboard can include at least one selected from the group consisting of a separation of the virtual keyboard, a position change of the virtual keyboard, a size change of the virtual keyboard, a type change of the virtual keyboard, a size change of keys within the virtual keyboard, a density change of the keys within the virtual keyboard and an arrangement change of the keys within the virtual keyboard.

To further achieve these objects and other advantages and in accordance with the purpose of the invention, as embodied and broadly described herein, according to one embodiment, a method of controlling a display device can include the steps of displaying a virtual keyboard on a flexible display unit of the display device, detecting a bending state of the flexible display unit and performing a modification of the virtual keyboard based on the detected bending state of the flexible display unit. The modification of the virtual keyboard can include at least one selected from the group consisting of a separation of the virtual keyboard, a position change of the virtual keyboard, a size change of the virtual keyboard, a type change of the virtual keyboard, size change of keys within the virtual keyboard, a density change of the keys within the virtual keyboard and an arrangement change of the keys within the virtual keyboard.

A display device according to the present specification can provide a more improved interface.

And, a display device according to the present specification can provide an improved input interface capable of preventing an input error of a user.

And, a display device according to the present specification can provide an input interface capable of more promptly inputting.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for an example of a display device according to one embodiment;

FIG. 2 is a diagram for a configuration of a display device according to one embodiment;

FIG. 3 is a diagram for a display device in which a virtual keyboard is displayed;

FIG. 4 is a diagram for states that a display device is bent;

FIG. 5 is a diagram for a slope that a display device is bent;

FIG. 6 is a diagram for a modification of a virtual keyboard according to one embodiment;

FIG. 7 is a diagram for a modification of a virtual keyboard according to a different embodiment;

FIG. 8 is a diagram for separation of a virtual keyboard according to one embodiment;

FIG. 9 is a diagram for combination of a virtual keyboard according to one embodiment;

FIGS. 10 to 12 are diagrams for examples of a separated virtual keyboard;

FIG. 13 is a flowchart for a method of controlling a display device.

### DETAILED DESCRIPTION OF THE INVENTION

Reference will now be made in detail to the preferred embodiments of the present specification, examples of which are illustrated in the accompanying drawings. While the embodiments have been concretely described with reference to the attached diagrams and the contents written on the diagrams, a scope of claims may be non-restricted or non-limited to the embodiments.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

FIG. 2 is a diagram for a configuration of a display device according to one embodiment.

The display device 100 can include a flexible display unit 120 configured to display at least one content, a bending sensing unit 130 configured to detect a bending state of the flexible display unit 120 and a processor 110 configured to control the bending sensing unit 130. Operations of the display device 100 disclosed in the present specification can also be performed by the processor 110.

The flexible display unit 120 can display one or more contents based on a command of the processor 110. For instance, the flexible display unit 120 can display a virtual keyboard as an input means. The flexible display unit 120 can include a LCD (liquid crystal display), a plasma display or a display of a different form. For instance, the flexible display unit 120 may include a transparent display unit. And, the flexible display unit 120 may include a touch sensor unit. The touch sensor unit can sense such various touch and non-touch inputs as a sliding touch input, a multi touch input, a long-press touch input, a short-press touch input, a drag touch input, a hovering input, a flicking touch input and the like. Moreover, the touch sensor unit can sense a touch input inputted by such various touch input tools as a touch pen, a stylus pen and the like. The touch sensor unit can deliver a result of sensing various touch inputs to the processor 110.

The bending sensing unit 130 can detect a bending state of the flexible display unit 120. The bending sensing unit 130 can detect the bending state of the flexible display unit 120 based on at least one selected from the group consisting of acceleration, voltage, charge amount, pressure and resistance of points on the flexible display unit 130.

The processor 110 can control the flexible display unit 120 and the bending sensor unit 130. And, the processor 110 can control different components included in the display device 100. The processor 110 can execute various applications by processing data of the display device 100. And, the processor 110 can control contents executed in the display device 100 based on a control command. And, the processor 110 can detect a bending state of the flexible display unit 120 using the bending sensor unit 130.

And, the display device 100 can further include different components shown in FIG. 2. For instance, the display device 100 can further include a communication unit, a camera, a memory, a power supply, a housing, one or more sensors (e.g., an acceleration sensor, a gyro sensor, a terrestrial magnetism sensor, a GPS sensor, a pressure sensor, an altitude sensor or a proximity sensor), an audio reception unit, an audio output unit, or different components.

Meanwhile, FIG. 2 is a block diagram for a display device 100 according to one embodiment. Blocks indicated in a manner of being separated from each other show hardware configuration units of the display device in a manner of logically distinguishing the display device from each other. Hence, configuration units of the aforementioned display device 100 can be implemented by a single chip or a plurality of chips depending on a design of the display device. And, the components of the display device 100 can be connected with each other via a bus 150.

Meanwhile, the display device 100 according to the present specification can be controlled based on various inputs. For instance, the display device 100 may include a physical button or may receive an input from the physical button. And, the display device 100 may include an audio reception unit and can be controlled based on a received audio. And, the display device 100 can perform an image analysis using a camera and can be controlled based on an analyzed image. And, the display device 100 includes a touch sensing unit and can be controlled based on a touch inputted to the touch sensing unit. Moreover, the display device 100 can be controlled based on a combination of the aforementioned inputs. And, the display device 100 can be controlled based on the aforementioned inputs and a combination thereof.

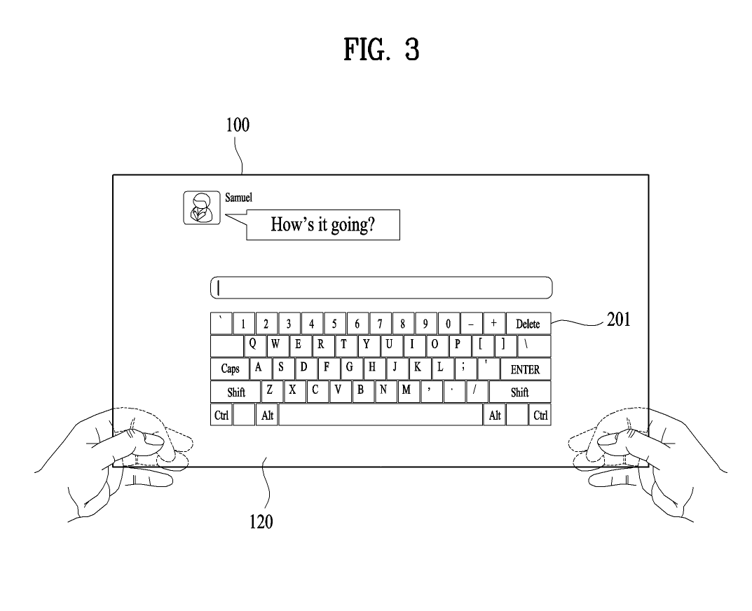

In the following, operations performed by the display device 100 are explained with reference to FIGS. 3 to 13. The aforementioned components of the display device 100 can be used for the operations of the display device 100 described in the following. And, an operation of the display device 100 and an operation of the processor 110 can be explained in a manner of being considered as identical to each other in the following description.

FIG. 3 is a diagram for a display device in which a virtual keyboard is displayed.

In FIG. 3, the display device 100 displays a virtual keyboard 201 on the flexible display unit 120 as an input means of a messenger application. The messenger application is just an example. The display device 100 can provide the virtual keyboard 210 as an input means of various applications. In FIG. 3, although the virtual keyboard corresponds to the QWERTY keyboard, it is able to provide the virtual keyboard 210 of a different form. The virtual keyboard 201 can be controlled based on a touch input. And, as mentioned in the following description, the virtual keyboard 201 can be controlled based on a bending state of the flexible display unit 120.

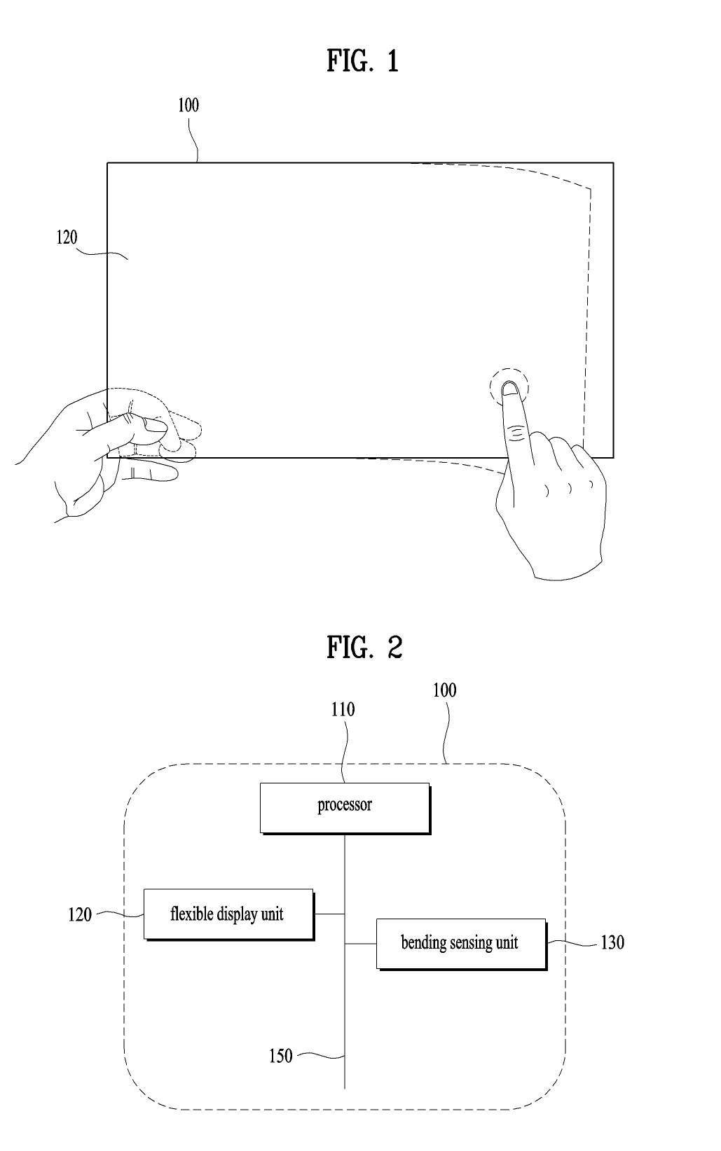

In general, the flexible display unit 120 is used to provide both portability and a wide screen. Although it is not depicted in FIG. 3, the flexible display unit 120 can be stored/rolled in a housing (not shown) of the display device 100. Yet, when the flexible display unit 120 is fully stretched out, a size of the flexible display unit 120 may be too big to carry by one hand. Hence, a user may carry the display device 100 by both hands or may put the display device on the floor. In this case, the flexible display unit 120 may be bent by hands or may be bent based on a shape of the floor. And, as mentioned earlier with reference to FIG. 1, if the flexible display unit 120 is bent, a problem of an input error may occur due to distortion of an image.

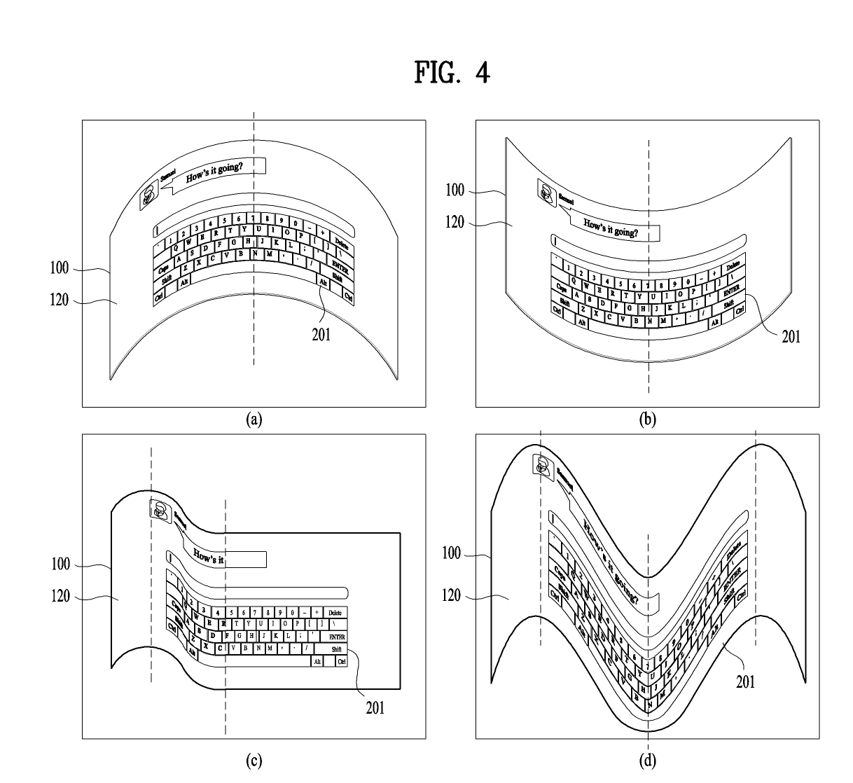

FIG. 4 is a diagram for states that a display device is bent.

As shown in FIG. 4, the display device 100 can be bent in various ways. In FIG. 4, an axis where the display device 100 is bent along is represented by a dotted line. For instance, as shown in FIG. 4 (a), the display device 100 can be convexly bent along one axis. And, as shown in FIG. 4 (b), the display device 100 can be concavely bent along one axis. And, as shown in FIG. 4 (c), the display device 100 can be bent along two axes. And, as shown in FIG. 4 (d), the display device 100 can be bent along three axes. The bending of the display device 100 shown in FIG. 4 (a) to (d) is just an example. The display device 100 can be bent in various ways.

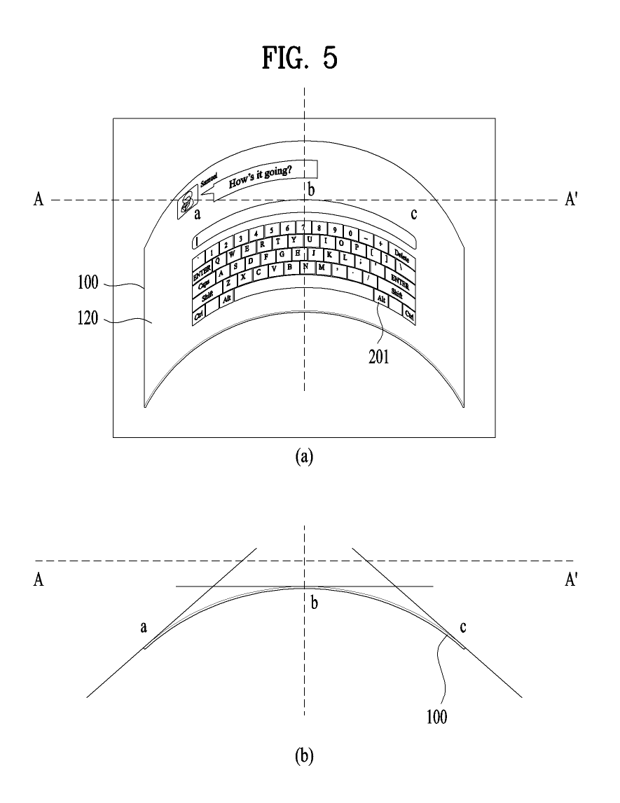

FIG. 5 is a diagram for a slope that a display device is bent.

As the display device 100 is bending, a slope of each point on the display device 100 may be different from each other. For instance, three points (a, b and c) on the bent display device 100 are depicted in FIG. 5 (a). And, FIG. 5 (b) shows a shape of the display device 100 seen from a side of the display device 100.

In FIGS. 5 (a) and (b), an A-A′ axis corresponds to an axis horizontal to the ground and becomes a criterion of measuring a slope in the present embodiment. As shown in FIG. 5 (b), a tangent line of a point b is horizontal to the ground (A-A′). Hence, a slope of the point b can be represented as 0 degree. On the contrary, a tangent line of a point a and a tangent line of a point a and a point c are not horizontal to the ground (A-A′). Hence, it can be represented as a slope of the point a and a slope of the point c are greater than the slope of the point b.

Yet, expression of the aforementioned slope is just an example. A slope can be measured by a relative value between the points on the flexible display unit 120. For instance, in case that slopes of all points on the flexible display unit 120 are identically measured, it is able to determine it as the flexible display unit 120 is not bent. And, although a slope may be represented by an absolute value of the slope, the slope may have both a positive value and a negative value.

And, the display device 100 can estimate a slope of each point on the flexible display unit 120 based on a bending state sensed by the bending sensing unit. For instance, the display device 100 can detect the bending state of the flexible display unit 120 based on at least one selected from the group consisting of acceleration, voltage, charged amount, pressure and resistance of the points on the flexible display unit 120. And, the display device 100 can evaluate or estimate a relative slope, a bending axis, flatness or continuity between the points on the flexible display unit 120 based on the bending state of the flexible display unit.

For instance, assume that slopes of two points on the flexible display unit 120 are changing from positive values to negative values. In this case, the display device 100 can estimate that there is a bending axis between the aforementioned two points. And, the display device can evaluate that there is no continuity between the two points. And, the display device 100 can evaluate flatness of the flexible display unit 120 in a manner of measuring a slope change between a plurality of points on the flexible display unit 120.

The display device 100 can modify an image or an input means (e.g., virtual keyboard 201) displayed on the flexible display unit 120 based on a bending state of the flexible display unit 120. For instance, modification of the virtual keyboard 201 can include at least one selected from the group consisting of separation of the virtual keyboard 201, position change of the virtual keyboard 201, type change of the virtual keyboard 201, size change of keys within the virtual keyboard 201, density change of the keys within the virtual keyboard 201 and arrangement change of the keys within the virtual keyboard 201.

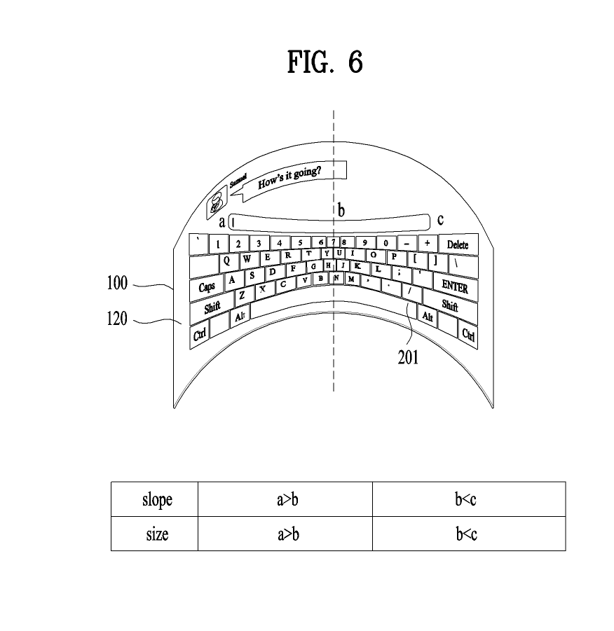

FIG. 6 is a diagram for a modification of a virtual keyboard according to one embodiment.

The display device 100 can modify the virtual keyboard 201 based on the slopes of the points on the flexible display unit 120 mentioned earlier with reference to FIG. 5. For instance, the display device 100 can modify at least one of a size of the virtual keyboard 201 and a size of keys within the virtual keyboard 201 based on the slope of each point.

In FIG. 6, the display device 100 is convexly bent along one axis. As mentioned earlier with reference to FIG. 5, the slope of the point a and the slope of the point c can be estimated as a slope greater than the slope of the point b. In this case, it may be not easy for a user to touch keys positioned at the points (points a and c) of stiff slope. Hence, the display device 100 may increase a size of the keys positioned at the point of stiff slope. Hence, as shown in FIG. 6, the size of the keys of the virtual keyboard 201 adjacent to the points a and c may be bigger than the size of the keys of the virtual keyboard 201 adjacent to the point b. Moreover, the display device 100 can increase a size of the virtual keyboard 201 for a region adjacent to the point of stiff slope. In FIG. 6, although the point a, b and c are depicted as examples, the display device 100 can estimate a slope for more points and may be then able to modify the virtual keyboard 201 based on the estimated slope.

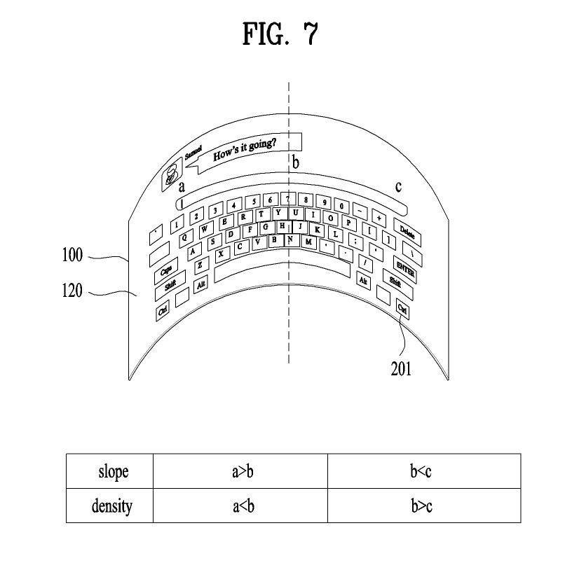

FIG. 7 is a diagram for a modification of a virtual keyboard according to a different embodiment.

Referring to FIG. 7, the display device 100 is convexly bent along one axis. As mentioned earlier with reference to FIG. 5, it is able to estimate that slopes of a point a and c are greater than a slope of a point b. In this case, the display device 100 can reduce density of keys positioned at the point of a stiff slope. For instance, the display device 100 can reduce the density of keys adjacent to a point of a slope greater than a predetermined slope. Hence, as shown in FIG. 7, the density of the keys of the virtual keyboard 201 adjacent to the points a and c may be less than the density of the keys of the virtual keyboard 201 adjacent to the point b.

And, the display device 100 can increase density of keys positioned at the point of a gentle slope. For instance, the display device 100 can increase the density of keys adjacent to a point of a slope less than a predetermined slope.

In FIG. 7, although the point a, b and c are depicted as examples, the display device 100 can estimate a slope for more points and may be then able to modify the density of the keys within the virtual keyboard 201 based on the estimated slope. And, the density change of the keys may include arrangement change of the keys within the virtual keyboard 201 or size change of the virtual keyboard 201.

Meanwhile, although it is not depicted in FIGS. 6 and 7, the display device 100 can evaluate flatness of each point on the flexible display unit 120 based on a slope of the each point on the flexible display unit 120 and continuity between points. And, the display device 100 can determine a flat surface of the flexible display unit 120 based on the flatness. For instance, in case that the left side and the right side of the flexible display unit 120 are bent, a surface between a left bending axis and a right bending axis can be determined as the flat surface of the flexible display unit 120. And, the display device 100 can modify at least one of a size of the virtual keyboard 201 and a position of the virtual keyboard based on a position and a size of the determined flat surface. For instance, it is able to determine that the flat surface is positioned between the left bending axis and the right bending axis. In this case, the display device 100 adjusts the size of the virtual keyboard 201 based on a distance between the left bending axis and the right bending axis and may be then able to move the position of the virtual keyboard 201 to the determined flat surface. Yet, the determination on the aforementioned flat surface is just an example. The flat surface can be determined based on points of which slopes are contiguously identical to the ground.

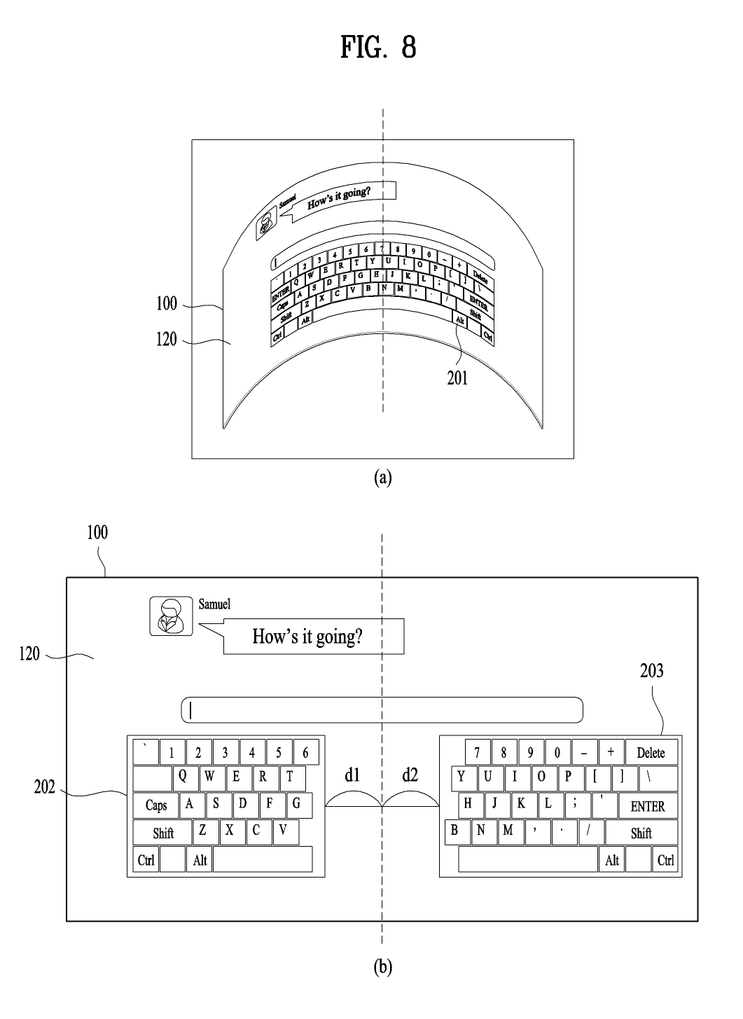

FIG. 8 is a diagram for separation of a virtual keyboard according to one embodiment.

Referring to FIG. 8 (a), the flexible display unit 120 is convexly bent along one axis. In this case, the display device 100 can detect an axis on which the flexible display unit 120 is bent. And, as shown in FIG. 8 (b), the display device 100 can separate the virtual keyboard 201 into a first virtual keyboard 202 and a second virtual keyboard 203 along the detected axis.

And, the display device 100 can provide at least one selected from the group consisting of a visual feedback, a tactile feedback, an auditory feedback and a vibration feedback in response to the separation of the virtual keyboard 201. For instance, when the virtual keyboard 201 is separated from each other, the display device 100 can indicate a user of the separation of the virtual keyboard 201 in a manner of providing a predetermined vibration feedback.

And, when the flexible display unit 120 is bent more than a predetermined angle along a bending axis, the display device 100 can divide the virtual keyboard 201. When the flexible display unit 120 is bent less than the predetermined angle, the display device 100 can combine the separated virtual keyboards 202/203 with each other into one virtual keyboard 201 again.

And, the first virtual keyboard 202 and the second virtual keyboard 203 may be displayed on a distance apart from a bending axis of the flexible display unit 120 as much as a predetermined distance. For instance, as shown in FIG. 8 (b), the first virtual keyboard 202 and the second virtual keyboard 203 can be displayed on a distance apart from the bending axis as much as a d1 and a d2, respectively.

The separation of the virtual keyboard 201 can be maintained only when the flexible display unit 120 is bent. And, if a predetermined action is not performed, the separation of the virtual keyboard 201 can be maintained despite the flexible display unit 120 is stretched out.

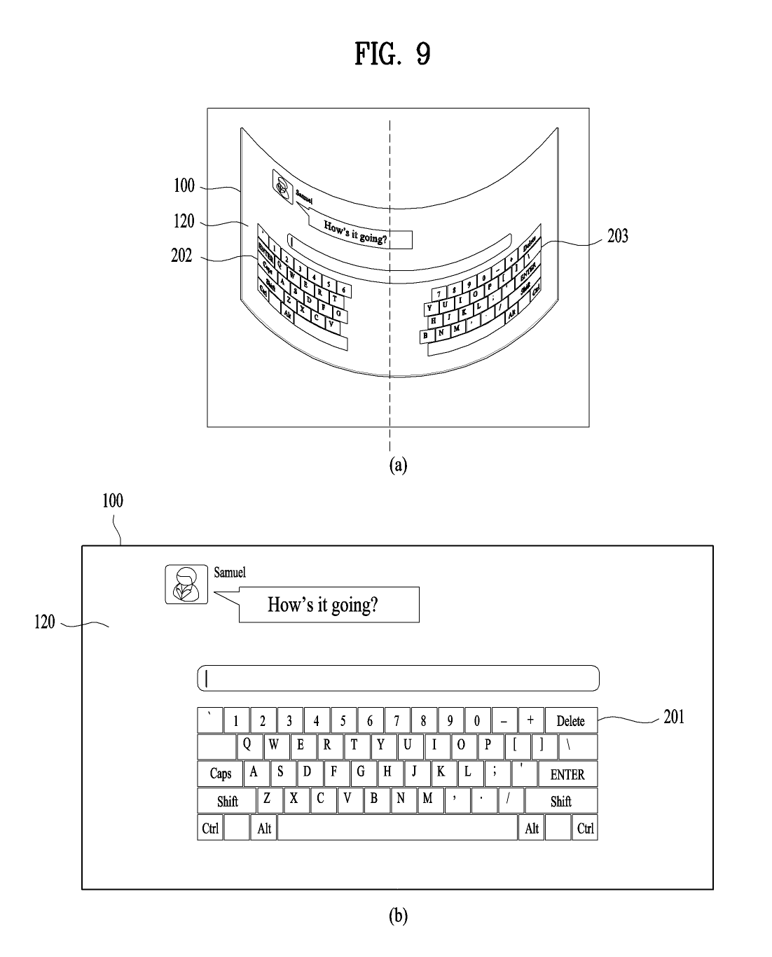

FIG. 9 is a diagram for combination of a virtual keyboard according to one embodiment.

As mentioned in the foregoing description, the separated virtual keyboards 202/203 can be combined with each other to form one virtual keyboard 201 again by a predetermined action. For instance, as shown in FIG. 9 (a), the flexible display unit 120 can be concavely bent. In this case, as shown in FIG. 9 (b), the display device 100 can combine the first virtual keyboard 202 and the second virtual keyboard 203 with each other to form one virtual keyboard 201.

FIGS. 10 to 12 are diagrams for examples of a separated virtual keyboard.

Although FIGS. 8 and 9 show separated virtual keyboards 202/203 corresponding to a form that a QWERTY keyboard is separated from each other, the separated virtual keyboards 202/203 may correspond to a virtual keyboard of a form different from the form of the combined virtual keyboard 201.

For instance, as shown in FIG. 10, the first virtual keyboard 202 may correspond to a contracted keyboard and the second virtual keyboard 203 may correspond to a number pad. In particular, the first virtual keyboard 202 and the second virtual keyboard 203 may include character forms different from each other, respectively.

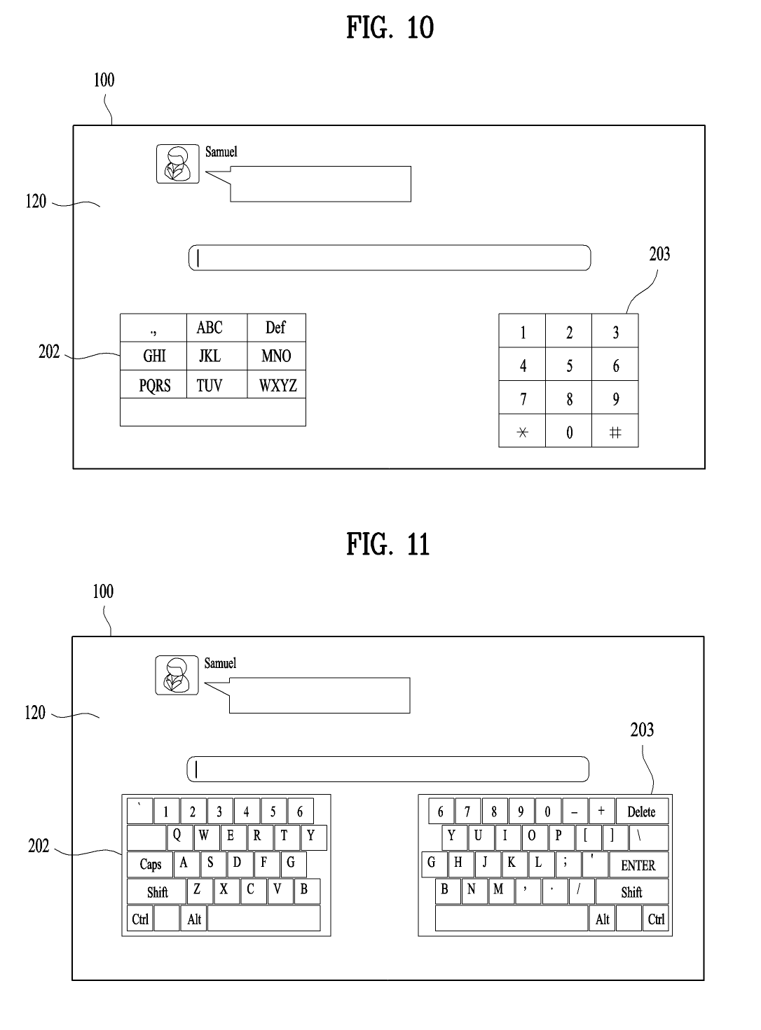

And, as shown in FIG. 11, at least a part of keys of the first virtual keyboard 202 and the second virtual keyboard 203 may be different from each other. Referring to FIG. 11, the first virtual keyboard 202 and the second virtual keyboard 203 respectively include the keys different from each other except several keys. In other word, at least a part of the keys of the first virtual keyboard 202 and the second virtual keyboard 203 can be identical to each other. For instance, as shown in FIG. 11, Y, G, H and a space key can be included in both the first virtual keyboard 202 and the second virtual keyboard 203.

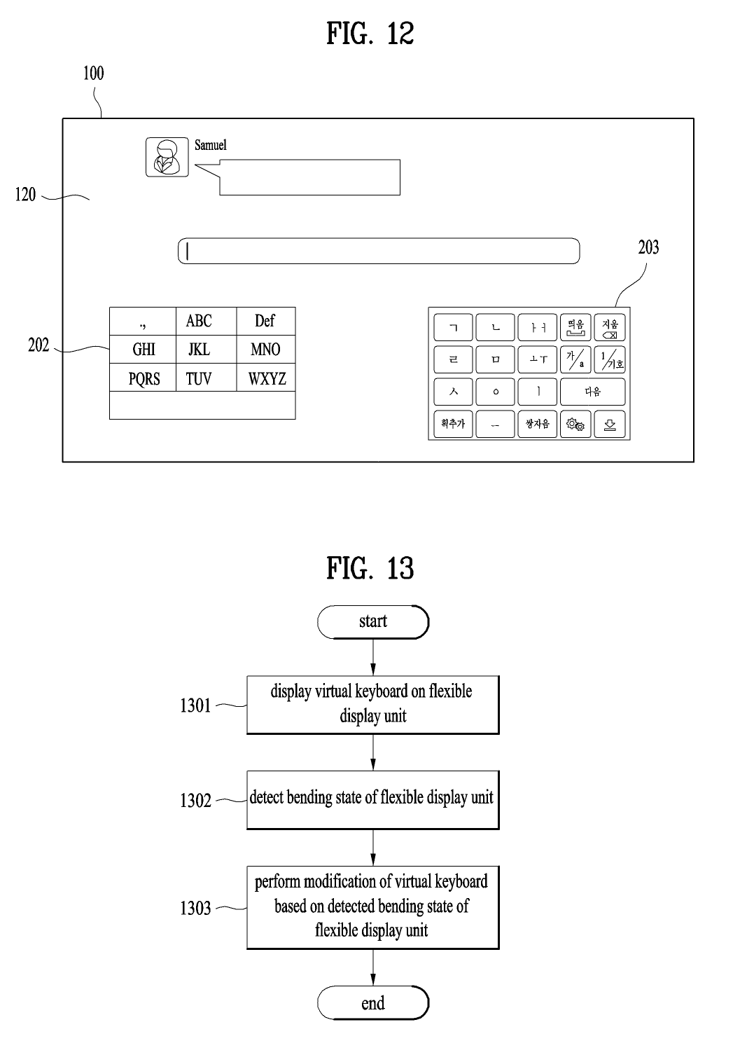

And, as shown in FIG. 12, the first virtual keyboard 202 may correspond to an English keyboard and the second virtual keyboard 203 may correspond to a Korean keyboard. In particular, the first virtual keyboard 202 and the second virtual keyboard 203 may include languages different from each other.

Referring back to FIG. 4, the display device 100 can perform a command associated with at least one of an input of the virtual keyboard 201 and a display of the virtual keyboard 201 based on a bending state of the flexible display unit 120.

For instance, as shown in FIG. 4 (a), in case that the flexible display unit 120 is convexly bent, the display device 100 may perform an operation identical to an enter input of the virtual keyboard 201. On the contrary, as shown in FIG. 4 (b), in case that the flexible display unit 120 is concavely bent, the display device 100 may perform an operation identical to a cancel input (e.g., backspace) of the virtual keyboard 201. The aforementioned matching between the input of the virtual keyboard 201 and the bending state of the flexible display unit 120 is just an example. Various functions can be matched with various bending states (e.g., FIG. 4 (a) to (d)).

For instance, as shown in FIG. 4 (a), in case that the flexible display unit 120 is convexly bent, the display device 100 may display the virtual keyboard 201 on the display unit 120. On the contrary, as shown in FIG. 4 (b), in case that the flexible display unit 120 is concavely bent, the display device 100 may stop displaying the virtual keyboard 201. The aforementioned matching between the display of the virtual keyboard 201 and the bending state of the flexible display unit 120 is just an example.

Meanwhile, it is apparent to those having ordinary skill in the art that configurations and operations of the display device mentioned earlier with reference to FIGS. 1 to 12 can be combined with each other. And, the aforementioned operations of the display device correspond to embodiments of the display device and may be combined with each other. In the following, a method of controlling the display device disclosed in the present specification is described. The method of controlling the display device described in the following can be combined with the configurations and the operations of the display device mentioned earlier with reference to FIGS. 1 to 12.

FIG. 13 is a flowchart for a method of controlling a display device.

A display device displays a virtual keyboard on a flexible display unit [S1301]. The display device can include a configuration of the display device mentioned earlier with reference to FIGS. 1 and 2. And, as mentioned earlier with reference to FIG. 3, the display device can display the virtual keyboard of various types as an input means of various applications.

The display device detects a bending state of the flexible display unit [S1302]. As mentioned earlier with reference to FIG. 2 and FIG. 4, the bending state of the flexible unit can be detected in various ways. And, as mentioned earlier with reference to FIGS. 2 to 5, the display device can estimate a slope of each point on the flexible display unit based on the bending state.

The display device performs a modification of the virtual keyboard based on the detected bending state of the flexible display unit [S1303]. The modification of the virtual keyboard can include at least one selected from the group consisting of separation of the virtual keyboard, position change of the virtual keyboard, size change of the virtual keyboard, type change of the virtual keyboard, size change of keys within the virtual keyboard, density change of the keys within the virtual keyboard and arrangement change of the keys within the virtual keyboard. And, the display device can perform various modifications on the virtual keyboard mentioned earlier with reference to FIG. 3 to FIG. 12. For instance, the display device can modify the virtual keyboard based on slopes of estimated points and may divide the virtual keyboard into two along a detected bending axis.

A display device according to the present specification and a method of controlling therefor may be not limited to a configuration and a method of the aforementioned embodiments. Instead, various modifications can be achieved in a manner that all or a part of each of the embodiments is selectively combined with each other.

Meanwhile, a display device according to the present specification and a method of controlling therefor can be implemented with a software readable by a processor in a recording media readable by the processor, which is equipped in the display device. The recording media readable by the processor may include all kinds of recording devices for storing data capable of being read by the processor. The examples of the recording media readable by the processor may include a ROM, a RAM, a CD-ROM, a magnetic tape, a floppy disc, an optical data storing device and the like. The recording media readable by the processor are distributed to the computer systems connected by a network and codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

1. A display device, comprising:
a flexible display unit configured to display one or more contents;
a bending sensing unit configured to detect a bending state of the flexible display unit based on at least of acceleration, voltage, electric charge and resistance of points on the flexible display unit; and
a processor configured to control the flexible display unit and the bending sensing unit,
wherein the processor is further configured to display a virtual keyboard on the flexible display unit and perform a modification of the virtual keyboard based on the detected bending state of the flexible display unit, and
wherein the modification of the virtual keyboard comprises at least one selected from the group consisting of a separation of the virtual keyboard, a position change of the virtual keyboard, a size change of the virtual keyboard, a type change of the virtual keyboard, a size change of keys within the virtual keyboard, a density change of the keys within the virtual keyboard and an arrangement change of the keys within the virtual keyboard.

2. The display device of claim 1, wherein the processor is further configured to estimate slopes of points on the flexible display unit based on the detected bending state of the flexible display unit and perform the modification of the virtual keyboard based on the estimated slopes of the points.

3. The display device of claim 2, wherein the processor is further configured to increase a size of the keys within the virtual keyboard positioned at a point where the estimated slope is greater than a first slope.

4. The display device of claim 3, wherein the processor is further configured to decrease the size of the keys within the virtual keyboard positioned at a point where the estimated slope is less than a second slope.

5. The display device of claim 2, wherein the processor is further configured to decrease density of keys within the virtual keyboard positioned at a point where the estimated slope is greater than a first slope.

6. The display device of claim 5, wherein the processor is further configured to increase the density of the keys within the virtual keyboard positioned at a point where the estimated slope is less than a second slope.

7. The display device of claim 1, wherein the bending state comprises slopes of points on the flexible display unit and continuity between the points and
wherein the processor is further configured to:
evaluate flatness of each point of the flexible display unit based on the slopes and the continuity,
determine a flat surface of the flexible display unit based on the evaluated flatness, and
modify at least one of a position and a size of the virtual keyboard based on a position and a size of the determined flat surface.

8. The display device of claim 1, wherein the processor is further configured to detect an axis along which the flexible display unit is bent and to separate the virtual keyboard into a first virtual keyboard and a second virtual keyboard on the basis of the detected axis.

9. The display device of claim 8, wherein the processor is further configured to respectively display the first virtual keyboard and the second virtual keyboard on positions of the flexible display unit apart from the detected axis as much as a predetermined distance.

10. The display device of claim 8, wherein the processor is further configured to separate the virtual keyboard along the detected axis when the flexible display unit is bent more than a predetermined angle along the detected axis.

11. The display device of claim 10, wherein the processor is further configured to combine the first virtual keyboard and the second virtual keyboard with each other to form one virtual keyboard when the flexible display unit is bent less than the predetermined angle along the detected axis.

12. The display device of claim 8, wherein at least a part of keys of the first virtual keyboard are different from at least a part of keys of the second virtual keyboard.

13. The display device of claim 12, wherein the first virtual keyboard and the second virtual keyboard comprise languages or character types different from each other.

14. The display device of claim 8, wherein at least a part of keys of the first virtual keyboard are identical to at least a part of keys of the second virtual keyboard.

15. The display device of claim 8, wherein the processor is further configured to provide at least one selected from the group consisting of a visual feedback, a tactile feedback, an auditory feedback and a vibration feedback in response to the separation of the virtual keyboard.

16. The display device of claim 8, wherein the processor is further configured to:
if the flexible display unit is convexly bent, separate the virtual keyboard into the first virtual keyboard and the second virtual keyboard and
if the flexible display unit is concavely bent, combine the first virtual keyboard and the second virtual keyboard into one virtual keyboard.

17. The display device of claim 1, wherein the processor is further configured to:
if the flexible display unit is convexly bent, perform a first command, and
if the flexible display unit is concavely bent, perform a second command and
wherein the first command and the second command are associated with at least one of an input of the virtual keyboard and a display of the virtual keyboard.

18. (canceled)

19. A method of controlling a display device, comprising the steps of:
displaying a virtual keyboard on a flexible display unit of the display device;
detecting a bending state of the flexible display unit based on at least one of acceleration, voltage, electric charge and resistance of points on the flexible display unit; and
performing a modification of the virtual keyboard based on the detected bending state of the flexible display unit,
wherein the modification of the virtual keyboard comprises at least one selected from the group consisting of a separation of the virtual keyboard, a position change of the virtual keyboard, a size change of the virtual keyboard, a type change of the virtual keyboard, a size change of keys within the virtual keyboard, a density change of the keys within the virtual keyboard and an arrangement change of the keys within the virtual keyboard.

20. The method of claim 19, further comprising the step of estimating slopes of points on the flexible display unit based on the detected bending state of the flexible display unit, wherein the step of performing the modification of the virtual keyboard comprises a step of performing the modification of the virtual keyboard based on the estimated slopes of the points.

21. The method of claim 19, wherein the step of detecting the bending state comprises a step of detecting an axis along which the flexible display unit is bent and wherein the step of performing the modification of the virtual keyboard comprises a step of separating the virtual keyboard into a first virtual keyboard and a second virtual keyboard on the basis of the detected axis.

22. The method of claim 19, further comprising the steps of:
if the flexible display unit is convexly bent, performing a first command; and
if the flexible display unit is concavely bent, performing a second command,
wherein the first command and the second command are associated with at least one of an input of the virtual keyboard and a display of the virtual keyboard.
